(19) United States
(12) Patent Application Publication
(10) Pub. No.: US 2015/0035952 A1
(43) Pub. Date: Feb. 5, 2015

(54) PHOTOGRAPHING APPARATUS, DISPLAY APPARATUS, PHOTOGRAPHING METHOD, AND COMPUTER READABLE RECORDING MEDIUM

(71) Applicant: Samsung Electronics Co., Ltd., Suwon-si (KR)

(72) Inventor: Takeshi Matsuo, Yokohama (JP)

(21) Appl. No.: 14/450,630

(22) Filed: Aug. 4, 2014

(30) Foreign Application Priority Data
Aug. 5, 2013 (JP) 2013-162642
Feb. 19, 2014 (KR) 10-2014-0019213

(51) Int. Cl. H04N 13/00; H04N 13/02

(52) U.S. Cl. CPC H04N 13/0022; H04N 13/0214; H04N 13/0296
USPC 348/49

(57) ABSTRACT

A photographing apparatus includes: a light blocking unit which selectively blocks light passing through a first lens unit; a disparity direction detection unit which detects a disparity direction of a user; a photographing controller which selects light block regions where the light is blocked by the light blocking unit and controls photographing a right-eye image and a left-eye image based on the disparity direction; and a storage unit which stores the right-eye image, the left-eye image, and information with regard to the disparity direction.

### CROSS-REFERENCE TO RELATED PATENT APPLICATIONS

This application claims the priority benefit of Korean Patent Application No. 10-2014-0019213, filed on Feb. 19, 2014, in the Korean Intellectual Property Office and Japanese Patent Application No. 2013-162642, filed on Aug. 5, 2013, in the Japan Patent Office, the disclosures of which are incorporated by reference herein in their entireties.

### BACKGROUND

1. Field

One or more embodiments of the present disclosure relate to a photographing apparatus, a display apparatus, a photographing method, and a photographing program.

2. Related Art

Photographing apparatuses such as digital cameras capable of photographing three-dimensional (3D) images have been developed.

For example, Japanese patent publication JP P2012-220907 discloses a photographing apparatus that takes 3D images by photographing a right-eye image and a left-eye image by separately allowing light only for the right eye and light only for the left eye to pass therethrough by blocking some light from received light. However, a photographing apparatus is not able to determine a disparity direction of a user, and thus, 3D images cannot be photographed as intended by the user.

In addition, Japanese patent publication JP P2012-128251 discloses a technology for a photographing apparatus, whereby a pose direction of the photographing apparatus is detected based on gravity and a light block location of an aperture is rotated by about 90 degrees according to whether the pose direction of the photographing apparatus is along a vertical direction or a horizontal direction. Thus, the photographing apparatus may photograph 3D images regardless of the pose direction of the photographing apparatus. However, detecting a photographing apparatus direction by using gravity does not mean that the photographing apparatus directly determines a disparity direction, and thus, the photographing apparatus may not always photograph appropriate 3D images. Thus, a method of detecting a photographing apparatus direction by using gravity is not necessarily helpful to appropriately detect a disparity direction of a user in consideration of a case where a camera faces upwards and photographs an image of a ceiling, a case where a camera faces downwards and photographs an image of a subject placed on a floor, or other cases.

### SUMMARY

A photographing apparatus appropriately determines a disparity direction of a user and changes a light block location according to the disparity direction in order to photograph three-dimensional (3D) images as intended by the user.

Various embodiments may solve one or more of the aforementioned problems and provide a photographing apparatus, a display apparatus, a photographing method, or a computer readable recording medium having a program capable of photographing or displaying 3D images that are photographed as intended by a user.

Additional features will be set forth in part in the description which follows and, in part, will be apparent from the description, or may be learned by practice of the presented embodiments.

According to one or more embodiments, a photographing apparatus includes: a light blocking unit which selectively blocks light passing through a first lens unit; a disparity direction detection unit which detects a disparity direction of a user; a photographing controller which selects light block regions where the light is blocked by the light blocking unit and controls photographing a right-eye image and a left-eye image based on the disparity direction; and a storage unit which stores the right-eye image, the left-eye image, and information with regard to the disparity direction.

The photographing controller may control the light blocking unit in order to block light for the left eye at a time when the right-eye image is photographed, and to block light for the right eye at a time when the left-eye image is photographed.

The photographing apparatus may further include a second photographing unit which receives light from a surface opposite a surface on which the first lens unit is installed. The disparity direction detection unit may detect locations of eyes of the user by using the second photographing unit, and may detect the disparity direction of the user based on the locations of the eyes of the user.

The photographing controller may control the disparity direction detection unit when the right-eye image and the left-eye image are photographed.

If the disparity direction detection unit is not able to detect the disparity direction of the unit, the photographing controller may select the light block regions where the light is blocked by the light blocking unit based on the information with regard to a last disparity direction which is detected by the disparity direction detection unit.

The photographing apparatus may further include a display unit which displays at least one of piece of information with regard to the light block regions of the light blocking unit, which is selected by the photographing controller, based on the information with regard to the disparity direction of the user or the disparity direction of the user detected by the disparity direction detection unit.

If the disparity direction detection unit is not able to detect the disparity direction of the user, the display unit may display at least one of piece of the information with regard to the light block regions of the light blocking unit selected by the photographing controller based on the information with regard to the disparity direction or a last disparity direction detected by the disparity direction detection unit.

The light block regions of the light blocking unit may be determined according to inputs of the user.

The photographing apparatus may further include a pose change detection unit which detects a pose change of the photographing apparatus. The photographing controller may control the disparity direction detection unit to execute a detection operation based on a detection result of the pose change detection unit.

If the detection operation of the disparity direction detection unit is not based on the detection result of the pose change detection unit, the photographing controller may select the light block regions of the light blocking unit based on the information with regard to a last disparity direction detected by the disparity direction detection unit, and the detection result of the pose change detection unit.

The photographing controller may not execute the detection operation of the disparity direction detection unit, and may select the light block regions of the light blocking unit based on the information with regard to a last disparity direction detected by the disparity direction detection unit and the detection result of the pose change detection unit in a case where the pose change detection unit detects that the photographing apparatus rotates around an optical axis of a lens of a lens unit.

The photographing apparatus may adjust an angle for displaying the right-eye image and the left-eye image, and generate images to be displayed on a display apparatus based on the right-eye image and the left-eye image, which are photographed by the photographing apparatus, and information with regard to the disparity direction.

The light blocking unit may include a liquid crystal shutter.

According to one or more embodiments, a display apparatus includes: a reproduction unit which reproduces a moving image file including a left-eye image, a right-eye image, and information with regard to a disparity direction during a photographic operation; an image processor which determines an angle for displaying the left-eye image and the right-eye image based on the information with regard to the disparity direction; and a display unit which displays the left-eye image and the right-eye image.

According to one or more embodiments, a method of controlling a photographing apparatus includes: detecting a disparity direction of a user; selecting light block regions where light is blocked based on the disparity direction; selectively blocking the light with the selected light block regions; photographing a right-eye image and a left-eye image; and storing the left-eye image and the right-eye image and information with regard to the disparity direction.

The selectively blocking of the light may include: blocking light for the left eye at a time when the right-eye image is photographed; and blocking light for the right eye at a time when the left-eye image is photographed.

The detecting of the disparity direction may include: detecting locations of eyes of the user by using a photographing unit arranged on a surface opposite a surface where light is received; and detecting the disparity direction of the user based on the locations of the eyes of the user.

The selectively selecting of the light block regions where the light is blocked may include selecting the light block regions where the light is blocked based on the information with regard to a last disparity direction which is detected when it is impossible to detect the disparity direction.

The method may further include: detecting a pose change of the photographing apparatus; and determining whether to detect the disparity direction based on a detection result of the pose change.

According to one or more embodiments, a computer readable recording medium having stored thereon a computer program, which when executed by a computer, performs a method of controlling a photographing apparatus, the method including: detecting a disparity direction of a user; selecting light block regions where light is blocked based on the disparity direction; selectively blocking the light; photographing a left-eye image and a right-eye image; and storing the left-eye image, the right-eye image, and information with regard to the disparity direction.

### BRIEF DESCRIPTION OF THE DRAWINGS

These and/or other embodiments will become apparent and more readily appreciated from the following description of various embodiments, taken in conjunction with the accompanying drawings in which:

FIG. 1 is a block diagram of a photographing apparatus according to an embodiment;

FIG. 2A shows an external surface of a smart phone as an example of the photographing apparatus of FIG. 1, the external surface facing a subject, according to an embodiment;

FIG. 2B shows an external surface of a smart phone as an example of the photographing apparatus of FIG. 1, the external facing a user, according to an embodiment;

FIGS. 3A through 3C, 4A through 4C and 5A through 5C are views for respectively explaining relations between a disparity direction of a user and light block regions of a light blocking unit;

FIG. 6 is a flowchart for explaining a method of controlling a photographing apparatus according to an embodiment;

FIG. 7 is a structural block diagram of a photographing apparatus according to another embodiment;

FIG. 8 is a flowchart for explaining a process of selecting a light block region according to another embodiment; and

FIG. 9 is a structural block diagram of a display apparatus according to another embodiment.

### DETAILED DESCRIPTION

Reference will now be made in detail to various embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain features of the present description. Expressions such as “at least one of,” when preceding a list of elements, modify the entire list of elements and do not modify the individual elements of the list.

While various embodiments have been particularly shown and described with reference to exemplary embodiments thereof, it will be understood by those of ordinary skill in the art that various changes in form and details may be made therein without departing from the spirit and scope of the invention as defined by the following claims.

Hereinafter, various embodiments will be described in detail by explaining embodiments of the invention with reference to the attached drawings.

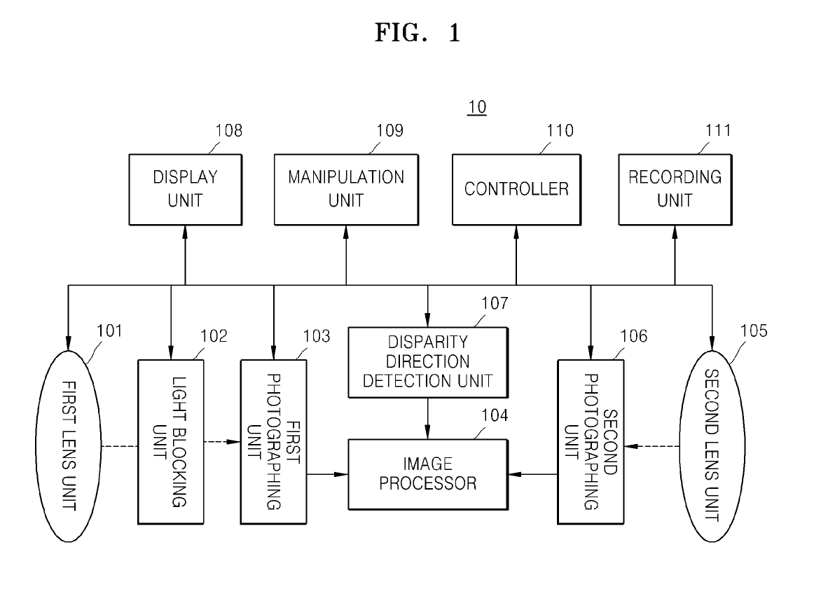

FIG. 1 is a block diagram of a photographing apparatus 10 according to an embodiment. The photographing apparatus 10 includes a first lens unit 101, a light blocking unit 102, a first photographing unit 103, an image processor 104, a second lens unit 105, a second photographing unit 106, a disparity direction detection unit 107, a display unit 108, a manipulation unit 109, a controller 110 and a recording unit 111.

The photographing apparatus 10 photographs three-dimensional (3D) images (a right-eye image is the image being recognized by the right eye of a user, and a left-eye image is the image being recognized by the left eye of the user). The photographing apparatus 10 may photograph a 3D image or may record a moving image formed of continuous display images. The photographing apparatus 10 may be a photographing apparatus (for example, a digital camera), a mobile terminal such as a smart phone, or other photographing apparatuses having image capturing capabilities. Descriptions of other components of the photographing apparatus 10 are omitted for clarity.

The first lens unit 101 receives light reflected from a subject that is a photographing target. The light reflected from the subject passes through the first lens unit 101 and is transmitted to the light blocking unit 102. The first lens unit 101 may be a single lens for photographing images. Alternatively, the first lens unit 101 may be a plurality of or sets of lenses.

The light blocking unit 102 blocks some light from the light received by the first lens unit 101, and changes light transmitted to the first photographing unit 103, thereby generating a disparity in the images. Accordingly, the photographing apparatus 10 may photograph a left-eye image and a right-eye image to be used for displaying 3D images.

For example, the light blocking unit 102 may use a device such as a liquid crystal shutter, which is capable of electrically changing regions where the light is transmitted (or light block regions) of the light blocking unit 102. Due to the above-described structure, a degree of freedom may be improved during a process when the light passage of the light blocking unit 102 is changed based on a disparity direction of a user.

According to another example, the light blocking unit 102 may be configured as an aperture, which allows light passage and is substantially open. In the present embodiment, the aperture rotates according to control of the controller 110, and thus, based on the disparity direction of the user, regions where the light is transmitted of the light blocking unit 102 may be changed.

The first photographing unit 103 photographs according to light reflected from the subject and transmitted by the light blocking unit 102, and then sends the photographed image to the image processor 104 in order to output the image. The first photographing unit 103 may be a complementary metal-oxide semiconductor (CMOS) image sensor or a charge-coupled device (CCD) image sensor.

Also, the first lens unit 101, the light blocking unit 102, and the first photographing unit 103 in one example form a rear-facing camera. The first lens unit 101 may be installed on a side opposite the display unit 108 of the photographing apparatus 10 (e.g., a side where the display unit 108 is not installed).

The second lens unit 105 is a lens unit installed on a side opposite the first lens unit 101 of the photographing apparatus 10. In other words, the first lens unit 101 and the second lens unit 102 face away from each other. A subject photographed by the second lens unit 105 may be the user, and the second lens unit 105 is a lens which receives light reflected from a face of the user. The light reflected from the face of the user is transmitted to the second photographing unit 106 through the second lens unit 105.

The second photographing unit 106 photographs according to light received by the second lens unit 105, and sends the photographed image to the image processor 104 in order to output the image. The second photographing unit 106 may be, for example, a CMOS image sensor or a CCD image sensor.

Also, the second lens unit 105 and the second photographing unit 106 in one example form a front-facing camera. The second lens unit 105 may be installed on a side where the display unit 108 of the photographing apparatus 10 is installed (for example, a side that is the same as the side where the display unit 108 is installed). When the face of the user faces the display unit 108, the light reflected from the face of the user is received by the second lens unit 105.

The image processor 104 executes operations such as interpolation or correction of image data output by the first photographing unit 103, and generates an image having a form recognized by the human eye, for example, an RGB form or a YCbCr form. Since regions where the light is transmitted by the light blocking unit 102 change, the image processor 104 may generate the left-eye image and the right-eye image with regard to the photographed subject.

In addition, the image processor 104 executes operations such as interpolation or correction of image data output by the second photographing unit 106, and outputs an image, which has a form such as an RGB form or a YCbCr form, from the image data output by the second photographing unit 106. Based on this structure, the image processor 104 may generate a facial image of the user.

The disparity direction detection unit 107 detects a relation between locations of the left and right eyes of the user, that is, the disparity direction of the photographer from the facial image of the user (for example, an image having an RGB form or a YCbCr form) generated by the image processor 104. The disparity direction detection unit 107 performs facial detection with one or more known methods, and may detect the disparity direction from a direction of the user's face. For example, the disparity direction detection unit 107 may detect the disparity direction of the user by detecting an angle difference between the disparity direction of the user (or the direction of the user's face) and a horizontal direction of the image photographed by the second photographing unit 106.

The display unit 108 may display the image of the subject photographed by the first lens unit 101 according to control of the controller 110. Accordingly, the user may check whether the subject that is the photographing target is appropriately photographed via the display unit 108. When the subject is not appropriately photographed, the user may adjust a direction of the photographing apparatus 10, and thus, may photograph an image of the subject that is appropriately located within a viewing angle of the first lens unit 101.

The manipulation unit 109 sends commands to the controller 110 of the photographing apparatus 10 when the user manipulates the photographing apparatus 10 in order to photograph images. The manipulation unit 109 may include, for example, a button such as a release button for starting a photographic operation, or may include a touch panel.

The controller 110 controls one or more elements of the photographing apparatus 10, and performs functions to control photographing processes. The controller 110, for example, controls the light block regions of the light blocking unit 102, and thus, the right-eye image and the left-eye image may be photographed as intended by the user. A detailed description of the above-described process is provided below. Furthermore, the controller 110 may include, for example, a central processing unit (CPU).

The images (that is, the right-eye image and the left-eye image) generated by the image processor 104 according to the control of the controller 110 are stored in the storage unit 111. Also, the storage unit 111 stores information with regard to the disparity direction which is detected by the disparity direction detection unit 107 when an image is photographed according to the control of the controller 110 and which is associated with each of the images. The storage unit 111, for example, may be a non-transitory computer readable recording medium such as a flash memory or a memory card, or may be a memory device installed in the photographing apparatus 10.

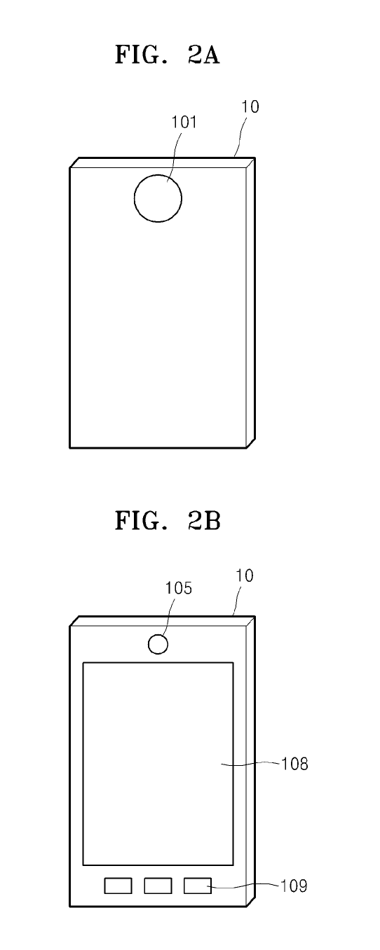

FIG. 2A shows an external surface of a smart phone that is an example of the photographing apparatus 10 of FIG. 1, the external surface facing the subject, according to an embodiment. The surface illustrated in FIG. 2A is a rear surface of a housing of the smart phone, and the first lens unit 101 is installed on the rear surface.

FIG. 2B shows an external surface of a smart phone that is an example of the photographing apparatus 10 of FIG. 1, the external surface facing the user, according to an embodiment. The surface illustrated in FIG. 2B is a front surface of the housing, which is opposite the surface shown in FIG. 2A, and the second lens unit 105, the display unit 108, and the manipulation unit 109 may be arranged on the surface of FIG. 2B. The smart phone according to the present embodiment enables the user to manipulate the manipulation unit 109 and to start to photograph an image while checking the display unit 108, and also enables the user to photograph an image by using the second lens unit 105 installed on the same surface as the display unit 108. Other components of the photographing apparatus 10 may be installed in the housing of the smart phone.

According to other embodiments, although the photographing apparatus 10 may be of another type (for example, a camera), the photographing apparatus 10 has an exterior that is similar to the embodiments shown in FIGS. 2A and 2B.

Hereinafter, photographing control of the photographing apparatus 10 will be described in detail.

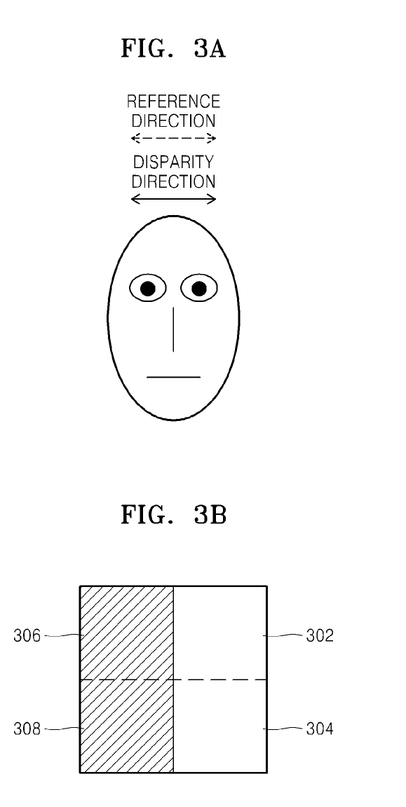

FIGS. 3A through 3C, FIGS. 4A through 4C, and FIGS. 5A through 5C are views for respectively explaining relations between the disparity direction of the user and the light block regions of the light blocking unit 102.

The disparity direction detection unit 107 may detect an angle between the disparity direction and a predetermined direction (hereinafter, referred to as a ‘reference direction’). For example, when the right eye and the left eye of the user are on a horizontal line in the image photographed by the second lens unit 105, and when the right eye is in a left portion and the left eye is in a right portion from a side of the second lens unit 105, it is considered that both eyes of the user are horizontally arranged in the reference direction. In other words, the disparity direction detection unit 107 may detect the relation between the locations of both eyes of the user based on a reference axis of the photographing apparatus 10 (for example, a disparity direction of a display apparatus for displaying images).

FIG. 3A is a view of a facial image of the user in the image photographed by the second lens unit 105. The disparity direction detection unit 107 determines that both eyes of the user are horizontally arranged in the reference direction based on the facial image of the user. The disparity direction detection unit 107 determines that the angle between the disparity direction and the reference direction is 0 degrees based on the facial image of the user illustrated in FIG. 3A.

In this regard, the controller 110 blocks light emitted from a left half or from a right half of the light blocking unit 102. For example, when the photographing apparatus 10 photographs a right-eye image of the subject, the controller 110 blocks the light received by the left half of the light blocking unit 102 at a side of the first photographing unit 103 (a side of the user), and transmits the light received by the right half of the light blocking unit 102 to the first photographing unit 103 as illustrated in FIG. 3B. On the contrary, when the photographing apparatus 10 photographs a left-eye image of the subject, the controller 110 blocks the light received by the right half of the light blocking unit 102 at the side of the first photographing unit 103, and transmits the light received by the left half to the first photographing unit 103 as illustrated in FIG. 3C.

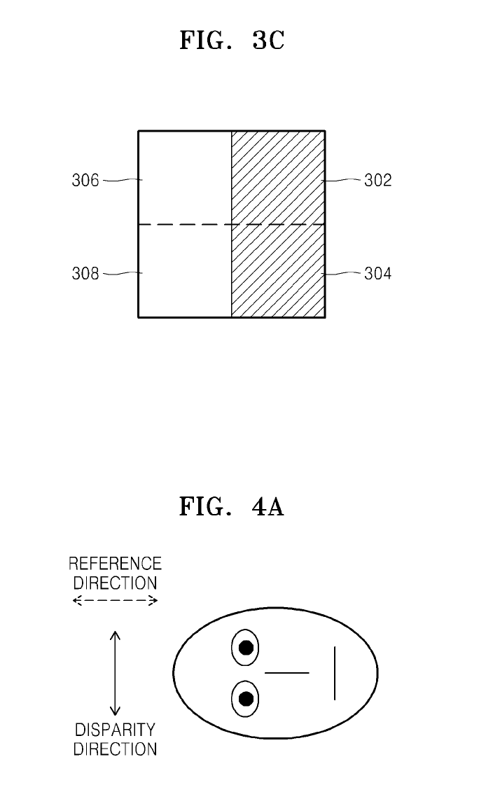

FIG. 4A is a view of a facial image of the user in the image photographed by the second lens unit 105. The disparity direction detection unit 107 detects that both eyes of the user are vertically arranged, and the left eye is disposed in a top portion and the right eye is disposed in a bottom portion based on the facial image of the user. The disparity direction detection unit 107 determines that the angle between the disparity direction and the reference direction is about 90 degrees in a counterclockwise direction or about 270 degrees in a clockwise direction based on the facial image of the user illustrated in FIG. 4A.

In this case, the controller 110 blocks light received by a top half or a bottom half of the light blocking unit 102. For example, when the photographing apparatus 10 photographs the right-eye image of the subject, the controller 110 blocks the light received by the top half of the light blocking unit 102, and transmits the light received by the bottom half to the first photographing unit 103 at the side of the first photographing unit 103 as illustrated in FIG. 4B. On the contrary, when the photographing apparatus 10 photographs the left-eye image of the subject, the controller 110 blocks the light received by the bottom half of the light blocking unit 102 and transmits the light received by the top half to the first photographing unit 103 at the side of the first photographing unit 103 as illustrated in FIG. 4C.

With reference to FIGS. 3B and 3C and FIGS. 4B and 4C, the light blocking unit 102 blocks some light received from a vertical direction or some light received from a horizontal direction, respectively. In other words, the light blocking unit 102 has a structure capable of blocking light in two directions (that is, a structure capable of blocking the light or passing the light received in four regions: upper right 302, lower right 304, upper left 306, and lower left 308). However, locations of the light block regions of the light blocking unit 102 are not limited thereto.

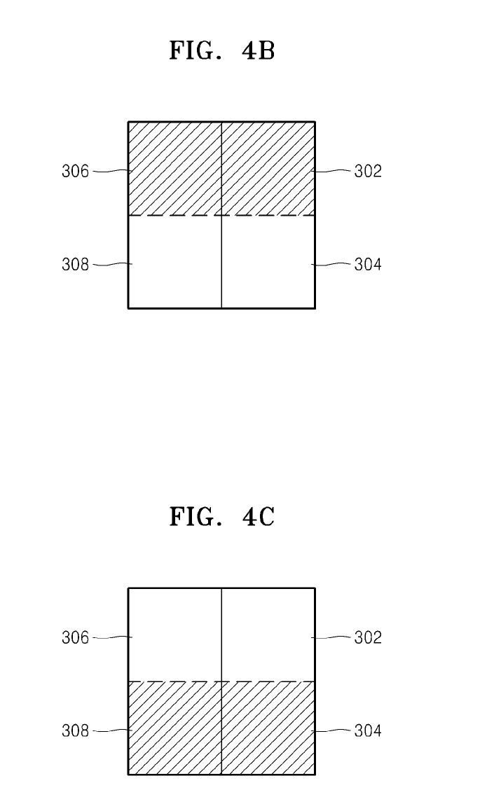

FIG. 5A is a view of a facial image of the user in the image photographed by the second lens unit 105. The disparity direction detection unit 107 detects that both eyes of the user are not arranged parallel to or perpendicular to the second lens unit 105, and that the left eye is disposed on the top portion and the right eye is disposed on the bottom portion based on the facial image of the user as illustrated in FIG. 5A. The disparity direction detection unit 107 determines the angle of the disparity direction to be (in the example of FIG. 5A) approximately 30 degrees in the counterclockwise direction or approximately 330 degrees in the clockwise direction.

In this regard, the controller 110 blocks the light received by a lower left half or an upper right half of the light blocking unit 102. For example, when the photographing apparatus 10 photographs the right-eye image of the subject, the controller 110 blocks the light received by the lower left half of the light blocking unit 102 and transmits the light received by the upper right half to the first photographing unit 103 at the side of the first photographing unit 103. On the contrary, when the photographing apparatus 10 photographs the left-eye image of the subject, the controller 110 blocks the light received by the upper right half of the light blocking unit 102 and transmits the light received by the lower left half to the first photographing unit 103 as illustrated in FIG. 5C. A state of the light blocking unit 102 illustrated in FIG. 5B is the same as a state in which the light blocking unit 102 of FIG. 3B is rotated by about 30 degrees in the counterclockwise direction. Likewise, a state of the light blocking unit 102 of FIG. 5C is the same as a state in which the light blocking unit 102 of FIG. 3C is rotated by about 30 degrees in the counterclockwise direction.

Since the light blocking unit 102 may block light in a certain region, the light blocking unit 102 may photograph the images (that is, the left-eye image and the right-eye image), which have a disparity therebetween when they are displayed, even though the face of the user (that is, the disparity direction of the user) is disposed in a direction other than a direction that is parallel to or perpendicular to the second lens unit 105.

When the light blocking unit 102 includes a liquid crystal shutter, the controller 110 changes a voltage applied to the liquid crystal shutter, and thus, may determine whether to block the light in a plurality of certain areas of the liquid crystal shutter. Due to the above-described structure, the controller 110 may control the light block regions 302, 304, 306, and 308 of the liquid crystal shutter as illustrated in FIGS. 3B, 3C, 4B, 4C, 5B, and 5C. In the present embodiment, a degree of freedom to change the light passage by using the liquid crystal shutter may be improved.

In addition, with reference to FIGS. 3B, 4B, and 5B, the light for the left eye is blocked in the light blocking unit 102, and with reference to FIGS. 3C, 4C, and 5C, the light for the right eye is blocked in the light blocking unit 102.

As described above, the disparity direction detection unit 107 detects the disparity direction of the user, and the controller 110 appropriately selects the light block regions (block locations) of the light blocking unit 102 according to a detection result. Therefore, the photographing apparatus 10 may photograph the right-eye image and the left-eye image.

The controller 110 associates the right-eye image and the left-eye image, which are generated by the image processor 104 based on the image data photographed by the first photographing unit 103, with the information with regard to the disparity direction (disparity direction information) detected by the disparity direction detection unit 107 while photographing each of the images. Then, the controller 110 stores the images associated with the disparity direction information in the storage unit 111. For example, the controller 111 stores the right-eye image and the left-eye image and the disparity direction information as one file in the storage unit 111, which is a recording medium. The disparity direction information denotes information specifying the disparity direction during a photographic operation. For example, when the images are photographed as illustrated in FIG. 3A, the disparity direction information may be set as “zero degrees”. Likewise, when the images are photographed as illustrated in FIG. 4A, the disparity direction information may be set as “about 90 degrees in the counterclockwise direction”. When the images are photographed as illustrated in FIG. 5A, the disparity direction information may be set as “about 30 degrees in the counterclockwise direction”.

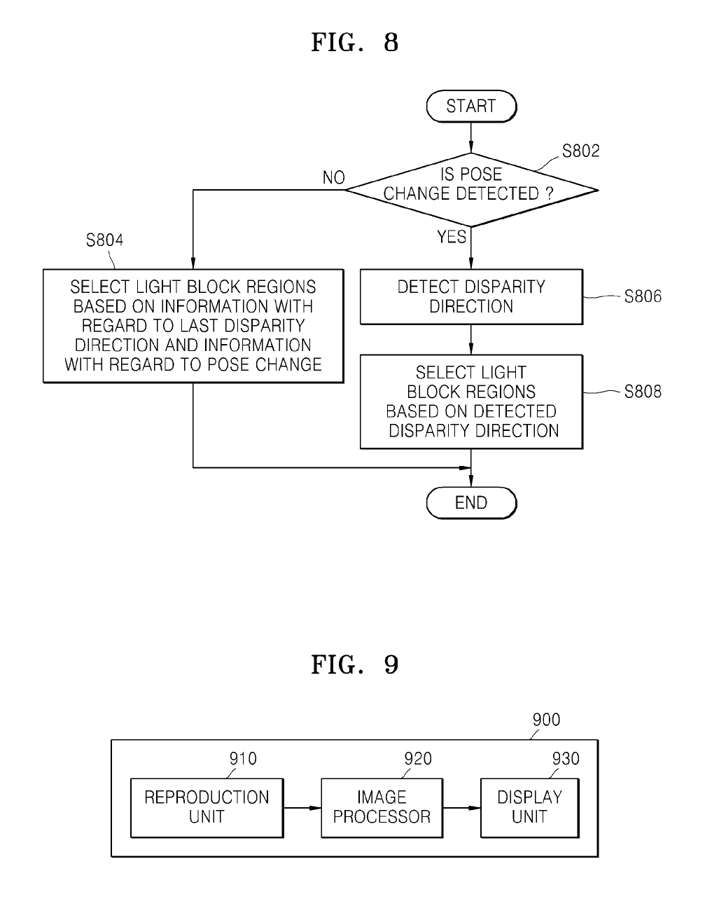

Through the above process, when the images stored in the storage unit 111 are displayed (reproduced) on a display apparatus 900 (FIG. 9) for displaying 3D images, the display apparatus 900 may adjust an angle for displaying the images based on the information with regard to the disparity direction associated with the images. For example, if the images are photographed as illustrated in FIG. 5A, when the images associated with the disparity direction information that is set as “about 30 degrees in the counterclockwise direction” are displayed as they are and the user looks at the displayed images, the displayed images appear as being tilted by about 30 degrees in the counterclockwise direction from a horizontal direction in comparison with conventional images. That is, an angular gap between the disparity direction of the display apparatus 900 and the disparity direction during the photographic operation is about 30 degrees. Therefore, the user may not properly see the images.

In various embodiments, the display apparatus 900 displays the images in a 30-degree tilt state in the clockwise direction, and thus, the display apparatus 900 may display the images in the same direction as the conventional images are displayed. In other words, the display apparatus 900 corrects for the disparity direction when the images are displayed, and thus the angular gap between the disparity direction of the display apparatus 900 and the disparity direction during the photographic operation may become zero degree or almost equal to zero degrees. Accordingly, the display apparatus 900 may 3-dimensionally display the images. In addition, by matching the reference axis of the photographing apparatus 10 with the disparity direction of the display apparatus 900, the display apparatus 900 may adjust an angle for displaying the images by using the disparity direction information which indicates the angular gap between the disparity directions.

An example of an execution process and effects of the photographing apparatus 10 are described as follows.

The photographing apparatus 10 photographs the right-eye image and the left-eye image in order to provide the images to the right eye and the left eye of the user, respectively. The light blocking unit 102 selectively blocks some light from the light passing through the first lens unit 101 (an optical system), and thus may transmit the light for the right eye and for the left eye into the photographing apparatus 10. The disparity direction detection unit 107 detects the disparity direction of the user (e.g., a user disparity direction). The controller 110 selects the regions (e.g., light block regions 302, 304, 306, or 308) where the light is blocked by the light blocking unit 102 based on the user disparity direction, blocks the light for the left eye at a time when the right-eye image is photographed, and blocks the light for the right eye at a time when the left-eye image is photographed. Therefore, the controller 110 controls the photographing apparatus 10 so as to photograph the right-eye image and the left-eye image at different times. Accordingly, the photographing apparatus 10 may photograph 3D images as intended by the user by directly detecting the user disparity direction. In particular, the photographing apparatus 10 may control the light passage in order to generate the right-eye image and the left-eye image, which form the 3D images.

Furthermore, the photographing apparatus 10 associates the photographed images for the right eye and the left eye with the user disparity direction information (e.g., information that indicates the user disparity direction detected by the disparity direction detection unit 107), and stores the images associated with the user disparity direction information. Thus, the display apparatus 900 may adjust the angle for displaying the images and display the images based on the user disparity direction information that is associated with the images and stored when the stored images are displayed (reproduced). Accordingly, the right-eye image and the left-eye image of which the angle for displaying the same are respectively provided to the right eye and the left eye of the user. That is, the display apparatus 900 may display the 3D images as intended by the user.

When photographed images are displayed, a display apparatus may not be able to display the images in an appropriate disparity direction. For example, a disparity direction of some 3D image display apparatuses may be fixed when it displays the images. In order to display the images in an appropriate 3D form, it is necessary to match the disparity direction of the display apparatus with a disparity direction when the images are photographed (that is, when displaying the images, it is necessary to rotate the images about the disparity direction when the images are photographed). However, information with regard to the disparity direction of the user must be stored when photographing the images in order to rotate the images when displaying the images. Therefore, it may not be possible to match the disparity direction of the user with the disparity direction while photographing the images. In the photographing apparatus 10, the information with regard to the disparity direction of the user is stored along with the 3D images, and thus, the display apparatus 900 may display the images in the appropriate 3D form.

According to another embodiment, the photographing apparatus 10 may adjust the angle for displaying the right-eye image and the left-eye image, and may generate images to be displayed on the display apparatus 900 based on the information with regard to the disparity direction detected by the disparity direction detection unit 107.

The generated images are stored in the storage unit 111. In the present embodiment, the display apparatus 900 displays the stored images as they are, and thus, the user may properly view the 3D images. Also, since the angle for displaying the images is adjusted, the generated images have a smaller size than conventional images and regions where no images are displayed (e.g., due to the rotation) may be displayed as a black (or other color) region.

The photographing apparatus 10 may include a user photographing unit (the second lens unit 105 and the second photographing unit 106) which photographs the user installed on a surface that is different from the surface on which the first lens unit 101 is installed (for example, the surface opposite to the surface on which the first lens unit 101 is installed). The disparity direction detection unit 107 may detect the disparity direction of the user by detecting the locations of the eyes of the user photographed by the user photographing unit. Accordingly, the disparity direction detection unit 107 may obtain the information with regard to the disparity direction of the user by using only a photographing device (the front-facing camera) that is frequently used in the photographing apparatus 10 without using special components.

In the photographing apparatus 10, the light blocking unit 102 may be a liquid crystal shutter. According to the present embodiment, a high degree of freedom of the light blocking unit 102 may be obtained in terms of controlling blocking of the light in comparison with a case where the light blocking unit 102 is an aperture of which thin blades are physically open, and the regions where the light is blocked may be more readily changed. Therefore, according to the present embodiment, the 3D images may be appropriately photographed based on the disparity direction of the user.

In addition to the above-described processes, the photographing apparatus 10 may perform the following processes.

First, the controller 110 may control the disparity direction detection unit 107 in order to operate the same under certain (e.g., predetermined) conditions. Accordingly, the disparity direction detection unit 107 consumes less power, and thus, power consumption of the photographing apparatus 10 may be also reduced.

Next, as an example of the predetermined conditions, the controller 110 may operate the disparity direction detection unit 107 in a case where the user photographs the right-eye image and the left-eye image of the subject. In particular, when the user inputs a command to the manipulation unit 109 to photograph an image, the controller 110 may detect the transmitted command, and may control the disparity direction detection unit 107 to change a non-operation state thereof into an operation state. In addition, when the user slightly presses a release button of the manipulation unit (e.g., a half-press or when a focus is locked, that is, a step of preparing a photographing operation), the controller 110 may operate the disparity direction detection unit 107. In this case, the controller blocks the light of the light blocking unit 102 according to a detection result of the disparity direction detection unit 107, and thus, the photographing apparatus 10 may photograph the subject.

When the photographic operation is finished (when a predetermined time that is set as a photographing time in the photographing apparatus 10 elapses, or when the user manipulates the manipulation unit 109 and inputs a command to the photographing apparatus 10 to finish the photographic operation), the controller 110 may stop operations of the disparity direction detection unit 107. Thus, unnecessary power consumption, which is consumed when the disparity direction detection unit 107 operates for an unnecessary time, may be reduced.

With regard to the second lens unit 105 and the second photographing unit 106 (the front-facing camera), the controller may control the second lens unit 105 and the second photographing unit 106 in order to operate or stop the same through the same process as the disparity direction detection unit 107.

Furthermore, the controller 110 may operate the disparity direction detection unit 107 within a predetermined time set in the manipulation unit 109 or set in the photographing apparatus 10 by the user.

Thirdly, when the disparity direction detection unit 107 may not be able to detect the disparity direction of the user, the controller 110 may select the regions where the light is blocked by the light blocking unit 102 based on the last disparity direction detected by the disparity direction detection unit 107 (e.g., the most recently detected disparity detection).

For example, when photographing images, the above-described process may take place when the user approaches a camera, which is an instance of the photographing apparatus 10, to look at a view finder and the face of the user comes too close to the view finder of the camera (that is, the face comes close within a predetermined distance). Therefore, the second lens unit 105 and the second photographing unit 106 may not clearly photograph the face of the user, and the disparity direction detection unit 107 may not detect the face of the user.

In this case, the controller 110 may determine the disparity direction based on a last facial detection result detected while the face of the user is close to the camera. Since the controller 110 determines the light block regions of the light blocking unit 102 based on the last disparity direction detected by the disparity direction detection unit 107, the controller 110 may photograph the 3D images based on data that is the most reliable. As a result, the photographing apparatus 10 may photograph the 3D images based on the appropriate disparity direction without complicated manipulation of the user.

Fourth, the display unit 108 of the photographing apparatus 10 may display any one of piece of information with regard to the light block regions of the light blocking unit 102, which is selected by the controller 110, based on the information with regard to the last (or recently detected) disparity direction detected by the disparity direction detection unit 107. In this regard, the controller 110 controls the display unit 108.

Under various conditions, the user may photograph an image at a disparity location that is different from the disparity direction of the user. In this case, the photographing apparatus 10 may output a signal instruction for the user to check whether the disparity direction or the light block regions of the light blocking unit 102 matches with the intention of the user by displaying any one of the information with regard to the last disparity direction detected by the display unit 108, and information with regard to the block region of the light blocking unit 102. Accordingly, the user may determine whether the images are photographed in an appropriate disparity direction.

Also, when the disparity direction detection unit 107 may not be able to detect the disparity direction of the user, the photographing apparatus 10 may display any one of the information with regard to the last disparity direction detected by the disparity direction detection unit 107, and the information with regard to the block region of the light blocking unit 102, which is selected by the controller 110 based on the disparity direction lastly detected by the disparity direction detection unit 107. In this case, the disparity direction detection unit 107 may not be able to detect the disparity direction of the user, and thus, it is rather necessary to check whether the images are photographed based on the appropriate disparity direction. Therefore, the user may determine whether the images are photographed in the appropriate disparity direction.

If a photographing apparatus is not able to appropriately determine a disparity direction of a user, the user may not be able to find whether the disparity direction is appropriately determined, and whether images are photographed at inappropriate light block regions. Therefore, the photographing apparatus 10 may be able to notify the information with regard to the disparity direction to the user, and thus the user may determine whether the images may be photographed in the appropriate disparity direction.

If disparity direction detected by the photographing apparatus 10 is different from the disparity direction that the user wants to use photographing images (for example, the disparity direction detected by the photographing apparatus 10 is not an actual disparity direction), the user manipulates the manipulation unit 109, and makes the controller 110 review one or more settings about the disparity direction or change the light block regions of the light blocking unit 102. Accordingly, the photographing apparatus 10 may photograph images in the appropriate disparity direction in a case where the disparity direction that the user wants to use is different from the disparity direction of the user or in other cases. Therefore, the photographing apparatus 10 may photograph images as intended by the user by rather flexibly reacting to various photographing conditions.

Also, if the photographing apparatus 10 is not able to determine the disparity direction of the user appropriately, the display unit 108 may display a message with regard to the above situation to the user.

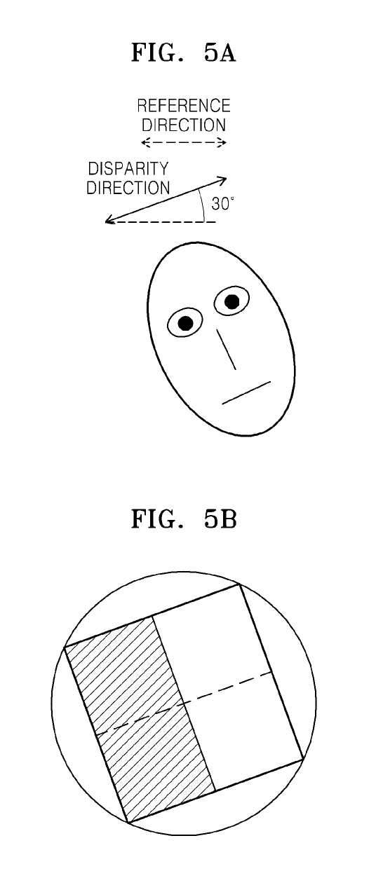

FIG. 6 is a flowchart illustrating an example of a method of controlling a photographing apparatus (e.g., the photographing apparatus 10) according to an embodiment.

According to the method of controlling the photographing apparatus, a disparity direction is detected first (S602).

Then, based on the detected disparity direction, light blocking regions in which light is blocked are selected (S604). The light blocking regions may be respectively selected with regard to a left-eye image and a right-eye image.

According to the method of controlling the photographing apparatus, when a shutter release signal is input, the light is blocked based on the light blocking region with regard to the left-eye image (S606), and then the left-eye image is photographed (S608). Similarly, the light is blocked based on the light blocking region with regard to the right-eye image (S606) and then the right-eye image is photographed (S608).

When the left-eye image and the right-eye image are generated, information with regard to the left-eye image and the right-eye image and information with regard to the disparity direction are stored (S610) in the recording unit 111.

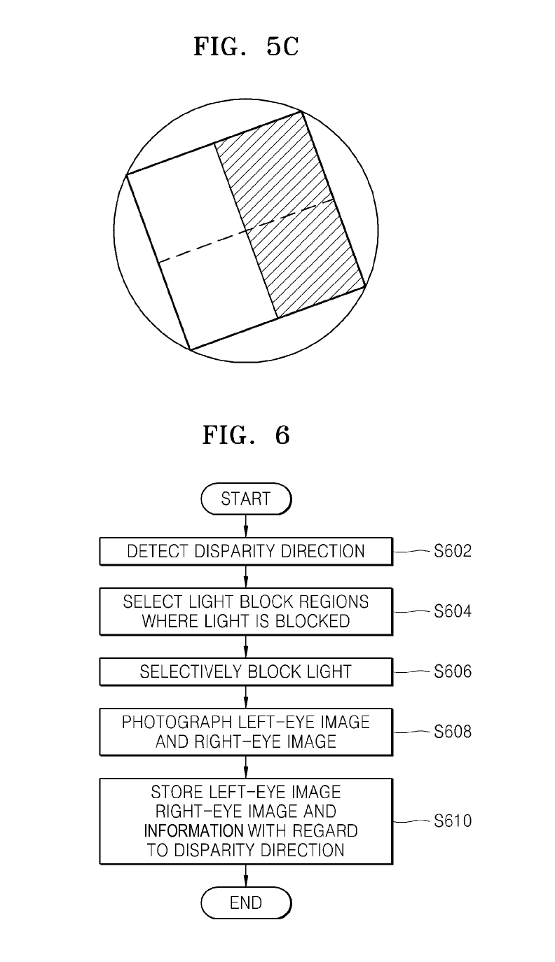

FIG. 7 is a structural block diagram of a photographing apparatus 20 according to another embodiment. The photographing apparatus 20 includes a first lens unit 201, a light blocking unit 202, a first photographing unit 203, an image processor 204, a second lens unit 205, a second photographing unit 206, a disparity direction detection unit 207, a display unit 208, a manipulation unit 209, a controller 210, a storage unit 211, and a pose change detection unit 212. In the present embodiment, the photographing apparatus 20 includes the elements of the photographing apparatus 10 of FIG. 1 and further includes the pose change detection unit 212. Components from the first lens unit 201 to the storage unit 211 have the same structures or functions as components from the first lens unit 101 to the storage unit 111 included in the photographing apparatus 10 of FIG. 1, and thus, their related descriptions are omitted.

The pose change detection unit 212 is a device (sensor) for detecting a pose (e.g., direction or orientation) change of the photographing apparatus 20. The pose change detection unit 212 may use, for example, an acceleration sensor. According to the present embodiment, the pose change detection unit 212 is used to detect whether poses of the photographing apparatus 20 are changed, and after the detection, power consumption of the photographing apparatus 20 may be limited and a change in the disparity direction may be determined.

For example, if it is assumed that the pose change detection unit 212 does not detect any pose change of the photographing apparatus 10 after the disparity direction detection unit 207 detects the last disparity direction, then in this case, the disparity direction detection unit 207 does not operate again to determine a subsequent disparity direction. Since the user maintains the photographing apparatus 20 in the same orientation or pose, the photographing apparatus 20 may determine that there is no change in the disparity direction of the user. Therefore, the controller 210 does not perform the detection operation again by re-operating the disparity direction detection unit 207, and may stop the disparity direction detection unit 207 from operating. The controller 210 selects the light block regions of the light blocking unit 202 based on the information with regard to the last disparity direction detected by the disparity direction detection unit 207, and the detection result of the pose change detection unit 212. Accordingly, the photographing apparatus 20 may photograph images based on the appropriate disparity direction.

In comparison with a process of the disparity direction detection unit 207 wherein a face of a subject is detected based on the images, less power is consumed when a process of the pose change detection unit 212 is performed by using a sensor. Therefore, according to the present embodiment, the photographing apparatus 20 may enable photographing of appropriate 3D images with reduced power consumption.

Although the disparity direction detection unit 207 does not operate, when the pose change detection unit 212 detects a pose change of the photographing apparatus 20, the controller 210 may execute any one of the following processes based on a state in which the disparity direction detection unit 207 detects the last disparity direction.

First, based on the information with regard to the last disparity direction detected by the disparity direction detection unit 207 and the detection result of the pose change detection unit 212, the controller 210 selects the light block regions of the light blocking unit 202. For example, when the pose change detection unit 212 detects that the photographing apparatus 20 rotates by a certain degree based on an optical axis of the lens of the lens unit 201, the controller 210 may change the light block regions of the light blocking unit 202 without re-performing the detection operation by the disparity direction detection unit 207 and without operating the disparity direction detection unit 207.

In particular, based on the facial image of the user as shown in FIG. 3A, when the user's face does not move and the user rotates the photographing apparatus 20 by about 30 degrees in the clockwise direction based on the optical axis of the lens, the user's face reflected on the second lens unit 105 is the same as the facial image of FIG. 5A. In this case, the pose change detection unit 212 detects that the photographing apparatus 20 is tilted by about 30 degrees in the clockwise direction based on the optical axis of the lens. According to a detection result, the controller 210 blocks some portions of the light blocking unit 202 as illustrated in FIGS. 5B and 5C. If the photographing apparatus 20 is rotated by about 90 degrees in the clockwise direction based on the optical axis of the lens, the controller 210 blocks some portions of the light blocking unit 202 as illustrated in FIGS. 4B and 4C through the same process.

In this case, since the photographing apparatus 20 just rotates around the optical axis of the lens, it is possible to assume that there are no changes in the location of the user as well as the subject. Therefore, the controller 210 may set the light block regions of the light blocking unit 202 without controlling the disparity direction detection unit 207.

Also, although the pose change detection unit 212 detects a pose change of the photographing apparatus 20, when the pose change is less than or equal to the predetermined threshold value, the controller 210 may select the light block regions of the light blocking unit 202 based on the information with regard to the last disparity direction detected by the disparity direction detection unit 207, and the detection result of the pose change detection unit 212.

As described above, the pose change detection unit 212 generally consumes less power than the disparity direction detection unit 207. Thus, the power consumption of the photographing apparatus 20 that takes 3D images may be reduced.

Second, when the pose change detection unit 212 detects a pose change of the photographing apparatus 20, the controller 210 may control the disparity direction detection unit 207 in order to detect the disparity direction in response to the detection result of the pose change detection unit 212.

In addition, when it is estimated that the pose change is equal to or greater than the predetermined threshold value based on the detection result of the pose change detection unit 212, the controller 210 controls the disparity direction detection unit 207 in order to re-detect the disparity direction. For example, if the pose (e.g., direction or orientation) of the photographing apparatus 20 is changed after the photographing apparatus 20 is rotated by about 5 degrees or more based on a selected or predetermined axis in a 3D space, the controller 210 controls the disparity direction detection unit 207 in order to re-detect the disparity direction. Moreover, the predetermined threshold value is not limited to 5 degrees, and may have another value.

Various embodiments may be applied to a photographing apparatus (for example, a digital camera and a smart phone) or a display apparatus which displays images photographed by the photographing apparatus (for example, a display apparatus having a display device such as TV).

Also, the invention is not limited to the above embodiments, and may be variously changed within the scope of the invention.

For example, according to the embodiment described with reference to FIG. 1, the reference direction of the disparity direction detection unit 107 is a horizontal direction when the images are photographed by the second lens unit 105. However, the direction may be a vertical direction or other directions.

Also, according to the embodiment described with reference to FIG. 1, the information with regard to the disparity direction that is stored in relation to the images includes a piece of information regarding an angle of the disparity direction that does not match with the reference direction, but is not limited thereto. If a piece of information specifies the disparity direction of the user, the information may also be acceptable.

The photographing apparatus may include a device capable of detecting a pose (e.g., direction or orientation) of the photographing apparatus as well as movements thereof. The controller of the photographing apparatus determines that there is no change in the disparity directions of the subject and the photographer if the disparity direction detection unit does not operate and if a movement distance of the photographing apparatus is equal to 0 or less than a predetermined threshold value. Then, the controller may stop the disparity direction detection unit from performing any operations. On the other hand, the controller of the photographing apparatus may control the disparity direction detection unit to restart the detection operation if the movement distance of the photographing apparatus is equal to or greater than the predetermined threshold value.

In addition, the light block regions of the light blocking region may be set according to an input of the user. The user may directly or indirectly set the light block regions of the light blocking unit through a user interface that is provided by using the display unit or the manipulation unit.

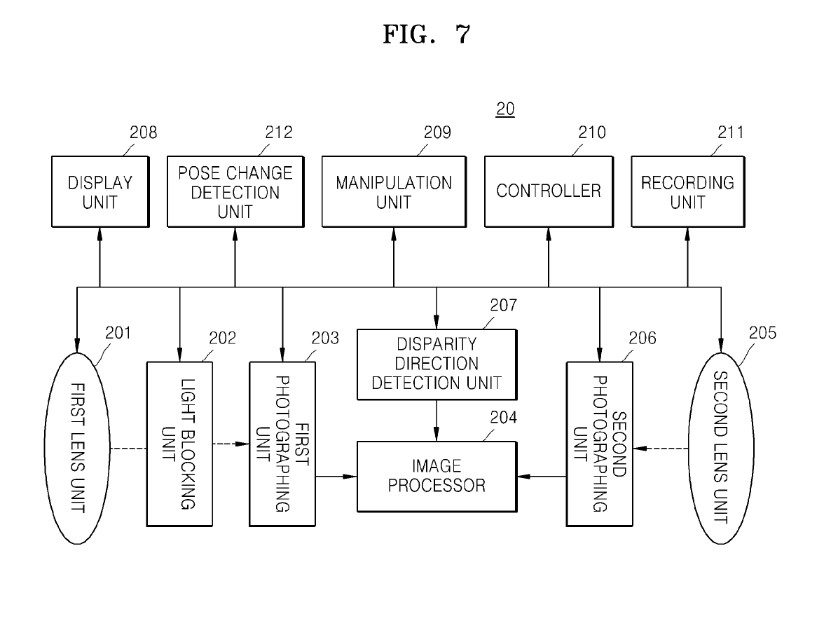

FIG. 8 is a flowchart for explaining a process of selecting light block regions according to another embodiment.

In the present embodiment, when a pose change is detected in the photographing apparatus (S802), a process of detecting the disparity direction is performed (S806), and when no pose change is detected, the process of detecting the disparity direction is not performed. The detection of the pose change may be performed by using an acceleration sensor, a gravity sensor, or the like include in the photographing apparatus.

When no pose change is detected, the light block regions are selected based on the information with regard to the last disparity direction that is detected, and the information with regard to the pose change (S804).

When a pose change is detected, the light block regions are selected based on the detected disparity direction (S808).

FIG. 9 is a structural view of a display apparatus 900 according to another embodiment. The display apparatus 900 includes a reproduction unit 910, an image processor 920, and a display unit 930.

The reproduction unit 910 reproduces moving or still image files. The image files include a left-eye image, a right-eye image, and the information with regard to a disparity direction when a photographic operation is performed. The information with regard to the disparity direction may be information generated according to the above-described embodiments.

The image processor 920 determines the angle for displaying the left-eye image and the right-eye image based on the information with regard to the disparity direction. For example, when the information with regard to the disparity direction is set as 30 degrees in the counterclockwise direction, the image processor 920 processes the left-eye image and the right-eye image in order to display them in a state in which the left-eye image and the right-eye image are tilted by 30 degrees in the clockwise direction, and displays them on the display unit 930.

The display unit 930 displays the left-eye image and the right-eye image output by the image processor 920.

As described above, one or more of the above embodiments, provide a photographing apparatus, a display apparatus, a photographing method, or a photographing program capable of photographing or displaying 3D images that are photographed as intended by a user.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A photographing apparatus comprising:
a light blocking unit which selectively blocks light passing through a first lens unit;
a disparity direction detection unit which detects a disparity direction of a user;
a photographing controller which selects light block regions where the light is blocked by the light blocking unit and controls photographing a right-eye image and a left-eye image based on the disparity direction; and
a storage unit which stores the right-eye image, the left-eye image, and information with regard to the disparity direction.

2. The photographing apparatus of claim 1, wherein the photographing controller controls the light blocking unit in order to block light for the left eye at a time when the right-eye image is photographed, and to block light for the right eye at a time when the left-eye image is photographed.

3. The photographing apparatus of claim 1, further comprising a second photographing unit which receives light from a surface opposite a surface on which the first lens unit is installed,
wherein the disparity direction detection unit detects locations of eyes of the user by using the second photographing unit, and detects the disparity direction of the user based on the locations of the eyes of the user.

4. The photographing apparatus of claim 1, wherein the photographing controller controls the disparity direction detection unit when the right-eye image and the left-eye image are photographed.

5. The photographing apparatus of claim 1, wherein, if the disparity direction detection unit is not able to detect the disparity direction of the unit, the photographing controller selects the light block regions where the light is blocked by the light blocking unit based on the information with regard to a last disparity direction which is detected by the disparity direction detection unit.

6. The photographing apparatus of claim 1, further comprising a display unit which displays at least one of piece of information with regard to the light block regions of the light blocking unit, which is selected by the photographing controller, based on the information with regard to the disparity direction of the user or the disparity direction of the user detected by the disparity direction detection unit.

7. The photographing apparatus of claim 6, wherein, if the disparity direction detection unit is not able to detect the disparity direction of the user, the display unit displays at least one of piece of the information with regard to the light block regions of the light blocking unit selected by the photographing controller based on the information with regard to the last disparity direction or the disparity direction detected by the disparity direction detection unit.

8. The photographing apparatus of claim 6, wherein the light block regions of the light blocking unit are determined according to inputs of the user.

9. The photographing apparatus of claim 1, further comprising a pose change detection unit which detects a pose change of the photographing apparatus,
wherein the photographing controller controls the disparity direction detection unit to execute a detection operation based on a detection result of the pose change detection unit.

10. The photographing apparatus of claim 9, wherein, if the detection operation of the disparity direction detection unit is not based on the detection result of the pose change detection unit, the photographing controller selects the light block regions of the light blocking unit based on the information with regard to a last disparity direction, which is detected by the disparity direction detection unit, and the detection result of the pose change detection unit.

11. The photographing apparatus of claim 9, wherein the photographing controller does not execute the detection operation of the disparity direction detection unit, and selects the light block regions of the light blocking unit based on the information with regard to the disparity direction detected by the disparity direction detection unit last and the detection result of the pose change detection unit in a case where the pose change detection unit detects that the photographing apparatus rotates around an optical axis of a lens of a lens unit.

12. The photographing apparatus of claim 1, wherein the photographing apparatus adjusts an angle for displaying the right-eye image and the left-eye image, and generates images to be displayed on a display apparatus based on the right-eye image and the left-eye image, which are photographed by the photographing apparatus, and information with regard to the disparity direction.

13. The photographing apparatus of claim 1, wherein the light blocking unit comprises a liquid crystal shutter.

14. A display apparatus comprising:
a reproduction unit which reproduces a moving image file, the moving image file comprising a left-eye image, a right-eye image, and information with regard to a disparity direction during a photographic operation;
an image processor which determines an angle for displaying the left-eye image and the right-eye image based on the information with regard to the disparity direction; and
a display unit which displays the left-eye image and the right-eye image.

15. A method of controlling a photographing apparatus, the method comprising:
detecting a disparity direction of a user;
selecting light block regions where light is blocked based on the disparity direction;
selectively blocking the light with the light block regions;
photographing a right-eye image and a left-eye image; and
storing the left-eye image and the right-eye image and information with regard to the disparity direction.

16. The method of claim 15, wherein the selectively blocking of the light comprises:
blocking light for the left eye at a time when the right-eye image is photographed; and
blocking light for the right eye at a time when the left-eye image is photographed.

17. The method of claim 15, wherein the detecting of the disparity direction comprising:
detecting locations of eyes of the user by using a photographing unit arranged on a surface opposite a surface where light is received; and
detecting the disparity direction of the user based on the locations of the eyes of the user.

18. The method of claim 15, wherein the selectively selecting of the light block regions where the light is blocked comprises selecting the light block regions where the light is blocked based on the information with regard to the disparity direction which is detected last when it is impossible to detect the disparity direction.

19. The method of claim 15, further comprising:
detecting a pose change of the photographing apparatus; and
determining whether to detect the disparity direction based on a detection result of the pose change.

20. A computer readable recording medium having stored thereon a computer program, which when executed by a computer, performs a method of controlling a photographing apparatus, the method comprising:
detecting a disparity direction of a user;
selecting light block regions where light is blocked based on the disparity direction;
selectively blocking the light;
photographing a left-eye image and a right-eye image; and
storing the left-eye image, the right-eye image, and information with regard to the disparity direction.
